(19) United States
(12) Patent Application Publication
(10) Pub. No.: US 2025/0107664 A1
(43) Pub. Date: Apr. 3, 2025

(54) Dessert & Food Warmer Display

(71) Applicant: Cortrell D Winkfield, Louisville, KY (US)

(72) Inventor: Cortrell D Winkfield, Louisville, KY (US)

(21) Appl. No.: 18/888,517

(22) Filed: Sep. 18, 2024

Related U.S. Application Data
(60) Provisional application No. 63/586,217, filed on Sep. 28, 2023.

(51) Int. Cl. A47J 39/02

(52) U.S. Cl. CPC A47J 39/02; A47J 2202/00

(57) ABSTRACT

The Dessert & Food Warmer Display with Cover is a cordless, rechargeable device designed to maintain the warmth of food while on display. The product consists of a base with an embedded rechargeable battery connected to a printed circuit board (PCB) and a top plate that houses a heating element. The heating element allows for adjustable temperature settings via a digital display panel, with controls to increase or decrease temperature and a timer feature that can be set for up to 4 hours, adjustable in 30-minute increments. The device can operate on battery power or while plugged in via USB-C charging. Additionally, the product includes a glass dome with ventilation holes to cover and protect the food while maintaining warmth. This invention is ideal for presenting baked goods and small dishes, keeping them at a consistent temperature during events or displays.

### BACKGROUND

### Field of the Invention

The present invention relates to the field of food displays and warming devices. Specifically, it pertains to a Dessert & Food Warmer Display that is designed to keep food items, such as desserts or baked goods, warm while on display. The device uses a rechargeable battery for cordless operation, incorporates a heating element in the top plate, and allows for adjustable temperature control and timer settings, making it suitable for both commercial and domestic use.

### Description of the Related Art

The present invention lies within the domain of food warming and display apparatuses, with a focus on maintaining the optimal serving temperature of desserts and other small dishes during display. Specifically, this invention pertains to a food warming display stand that not only showcases food but also keeps it warm using an embedded heating element. This invention serves both functional and aesthetic purposes, making it ideal for professional use in bakeries, catering events, and restaurants, as well as for domestic use during gatherings or special occasions.

Maintaining the right temperature for food while it is on display is crucial to ensuring its quality, freshness, and appeal. Food that is kept warm too long, or at improper temperatures, can dry out or spoil, negatively impacting both taste and texture. In professional settings, such as buffets, bakeries, and catered events, serving food at the right temperature can significantly enhance customer satisfaction. This invention offers a solution that ensures food is presented beautifully while also staying warm for extended periods, without the need for constant supervision. The ability to set and control temperature and time offers convenience, especially in high-volume settings where food needs to remain fresh and warm over several hours. Additionally, the cordless functionality of the invention provides increased flexibility and mobility, making it convenient for outdoor events or places with limited access to power outlets.

The food warming and display equipment market is experiencing steady growth, driven by the expanding hospitality industry and increasing consumer demand for fresh, high-quality food presentation. As of 2022, the global market for food warming displays was valued at approximately $1.4 billion, with significant growth forecasted in the coming years. With a projected compound annual growth rate (CAGR) of 5.2% between 2023 and 2028, the demand for portable and aesthetically pleasing food warming solutions is expected to rise. Restaurants, event organizers, and caterers are continuously seeking innovative products that enhance both food presentation and functionality, ensuring that food remains at its ideal serving temperature while being visually appealing.

Several food warming solutions currently available in the market offer innovations such as induction heating technology, electric chafing dishes, and heated display cases. These products have advanced food preservation and presentation by enabling temperature control and longer heat retention. For example, induction food warmers provide rapid heating but require specialized cookware and often remain tethered to power outlets, limiting portability. Similarly, electric buffet warmers are popular in banquet halls and hotels but are generally bulky and focus more on keeping large quantities of food warm rather than offering an elegant food display solution. While these products serve their intended purpose, they do not adequately address the need for mobility, portability, and aesthetics, which are increasingly important in modern catering and hospitality environments.

By looking at prior art multiple devices can be seen. For instance, a U.S. Pat. No. 4,757,913A introduces a cover unit for food warmer. The cover unit for a food warmer of the type comprising a food container. The cover unit comprises a frame for connection to the food container, a plurality of door members slidably supported on the frame and independently movable relative to said frame and to each other selectively to close said opening and to allow a selected amount of access to the food container. A pair of track members are provided for supporting and guiding each of the door members, with the track members being selectively connectable and removable from the frame and from the door members, to enable assembly and disassembly of the frame, the track means and the door members. The key components of the cover unit, i.e., the door members, track members and frame are formed, essentially of sheet metal parts, to facilitate manufacture of those components.

A US patent 2,022,0079379 discusses Food Warming System. The embodiments disclose a method including warming food in an integral heat tray insert of a food container, generating heat in the food container using electrical impedance of a plurality of heat dispersing elements, using a control printed circuit board assembly coupled to a power button for activating and controlling electrical components including the plurality of heat dispersing elements, adjusting heat temperatures from the plurality of heat dispersing elements for warming food to a comfortable and safe heat level, using at least one rechargeable battery pack coupled to the control printed circuit board assembly with a power button for activating electrical components including the plurality of heat dispersing elements, and transmitting food status information to a user and receiving user instructions from a user digital device using a food warming system application which includes a timer and variable heat control.

A Countertop display warmer bearing U.S. Pat. No. 4,074,108 discusses an illuminated display warmer for displaying food products while maintaining them at proper serving temperature. The warmer includes glass front and sides, a base providing a flat heating surface, and a ceiling from which is suspended a radiant heater for warming the product in the warmer chamber. Separate convective air flow paths ventilate the warmer chamber and provide for a low external surface temperature. The warmer is particularly adapted to be mounted on a countertop. Recessing of a low profile base heater permits such mounting without danger of burning or scorching of the countertop.

A U.S. Pat. No. 3,614,923a discusses a food warmer that including an upright cabinet having a warming and storage compartment, and a closed forced air heating system for providing moisture regulated heated air to the warming and storage compartment whereby food is kept warm under a controlled atmosphere.

Despite existing innovations, users continue to encounter significant challenges with food warming devices. One major shortcoming is the reliance on power cords, which limits the mobility of such devices and constrains their use in settings where electrical outlets are not easily accessible. Additionally, many food warmers lack precise temperature control, resulting in overheating or uneven warming of the food, which can compromise the quality of the dishes being served. Bulkier models often sacrifice aesthetics for function, making them unsuitable for high-end events where food presentation is as important as the taste. Another common issue is the lack of integrated timers, forcing users to constantly monitor the equipment to prevent over-warming or unnecessary energy consumption. These limitations highlight the need for a product that not only addresses food warming but does so with an emphasis on mobility, precision, and visual appeal.

The proposed Dessert & Food Warmer Display solves many of the challenges faced by current food warming solutions. The product is a versatile, cordless food warmer that operates using a rechargeable battery embedded in the base, offering complete portability and freedom from power cords. The top plate of the stand incorporates a built-in heating element that can be easily controlled through a digital interface, allowing users to adjust the temperature according to their specific needs. The display stand also features a user-friendly timer function, capable of being set for up to 4 hours in 30-minute increments, ensuring that food remains warm for the desired duration without constant supervision. The + and − buttons on the control panel make it easy to set precise temperatures, eliminating the risk of overcooking or drying out the food. Additionally, the stand can operate while plugged in via a USB-C charger, providing users with flexibility for both mobile and stationary applications.

The product includes a sleek, transparent glass dome with ventilation holes, designed to cover and protect the food while maintaining optimal warmth and preventing moisture buildup. This ensures that food stays fresh and visually appealing throughout the event, making it an ideal solution for upscale gatherings, catering events, and professional food service environments.

The Dessert & Food Warmer Display addresses a critical gap in the market by combining portability, precision, and elegant food presentation in one product. Existing food warming solutions often lack mobility and fine control over temperature settings, leading to inconsistent results or limited use cases. By incorporating a rechargeable battery and a compact, portable design, this invention allows users to place the warmer anywhere without the need for power outlets. This is especially useful for outdoor events, catering on the go, or venues with limited electrical infrastructure.

Moreover, the digital temperature controls and integrated timer give users unprecedented control over the heating process, ensuring that food remains at the ideal serving temperature without requiring manual adjustments. The sleek, modern design of the warmer, combined with its functionality, makes it not only a practical food-warming solution but also an attractive centerpiece that enhances the visual appeal of the food display.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide an advanced design and methodology for a Dessert & Food Warmer Display.

The invention aims to provide a cordless, rechargeable food-warming display that eliminates the need for power outlets, offering greater flexibility and portability in various settings.

It is a further objective of the present invention to maintain food at a consistent, user-set temperature, preventing overcooking or drying out while ensuring that food remains warm and ready to serve.

It is also an object of the invention to offer precise temperature control with easy-to-use digital buttons, allowing users to adjust the heat according to the specific requirements of different foods.

It is further the objective of the invention to incorporate a built-in timer function, enabling users to set warming durations up to 4 hours in 30-minute increments, reducing the need for constant monitoring.

It is also the objective of the invention to enhance food presentation with a sleek, modern design, making the food warmer an attractive centerpiece for events, restaurants, and catering services.

It is also the objective of the invention to provide dual power functionality, allowing users to operate the warmer using its rechargeable battery or while plugged in via USB-C for maximum convenience.

It is also the objective of the invention to incorporate a protective glass dome with ventilation holes, keeping food warm while preventing moisture buildup, and ensuring food stays fresh and appetizing.

It is further the objective of the invention to offer a flush, seamless heating surface that ensures even heat distribution across the entire food display, preventing cold spots and uneven warming.

It is also the objective of the invention to include an LED indicator light that informs users when the food warmer has reached the desired temperature, providing a clear visual cue for readiness.

Thus, it is the objective to provide a new and improved form of versatility in its application, making it suitable for various food types such as desserts, baked goods, and small dishes, in both professional and domestic settings.

It is the objective of the invention to create a durable and long-lasting device that resists wear and tear from repeated use.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the assembly view of the Dessert & Food Warmer Display as per preferred embodiments of the invention.

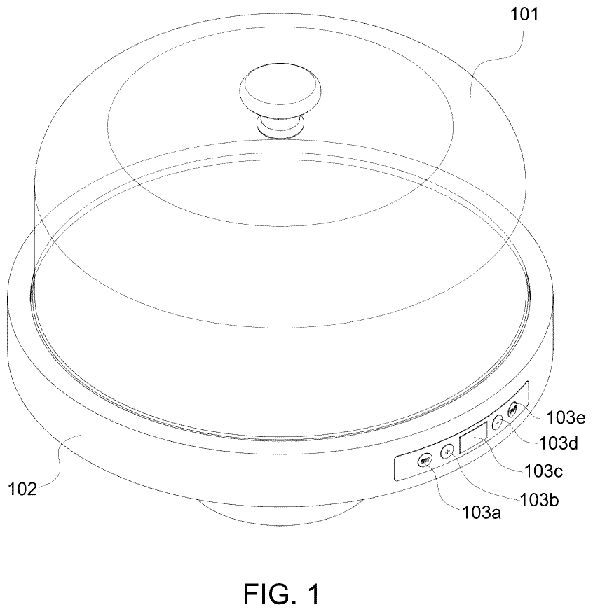

FIG. 2 shows the bottom-up view of the Dessert & Food Warmer Display cover as per preferred embodiments of the invention.

FIG. 3 shows the exploded top view of the Dessert & Food Warmer Display cover as per preferred embodiments of the invention.

FIG. 4 shows the exploded bottom view of the Dessert & Food Warmer Display cover as per preferred embodiments of the invention.

FIG. 5 shows the working view of the Dessert & Food Warmer Display cover as per preferred embodiments of the invention.

FIG. 6 shows the heating element of the Dessert & Food Warmer Display cover as per preferred embodiments of the invention.

FIG. 7 shows another view of the heating panel of the Dessert & Food Warmer Display cover as per preferred embodiments of the invention.

FIG. 8 shows the display panel of the Dessert & Food Warmer Display cover as per preferred embodiments of the invention.

FIG. 9 shows the shows another view of the Dessert & Food Warmer Display cover as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention introduces a Dessert & Food Warmer Display, is specifically designed to maintain the warmth of food items such as cakes, pastries, and other baked goods while on display. The core of the invention lies in its cordless functionality, enabled by an embedded rechargeable battery located in the base of the stand. This battery powers the entire device, offering portability and convenience for use in a variety of settings, including outdoor events, catered parties, and high-end buffets. Unlike conventional food warmers that rely on a constant electrical connection, the battery provides extended cordless operation, allowing users the flexibility to move and place the warmer wherever needed.

As per its preferred embodiments, the top plate of the warmer features an embedded heating element, which is responsible for generating and maintaining heat. This element is seamlessly integrated into the top plate, ensuring that the surface remains smooth and uninterrupted for easy food placement. The heating element is designed to evenly distribute heat across the top plate, preventing uneven warming or cold spots. This feature is particularly important when displaying delicate food items, as it ensures that the entire surface area receives consistent warmth, preserving the quality of the food.

As per its preferred embodiments, the temperature control is one of the key features of the invention. Users can adjust the temperature settings using a digital display panel located on the base of the stand. The panel includes + and − buttons that allow for precise temperature adjustments. This flexibility is crucial when warming different types of food that may require specific heat settings. For instance, delicate pastries may need to be kept at a lower temperature, while heartier items like bread or cookies may require a slightly higher setting. The digital control ensures that users can customize the temperature to suit the type of food on display, enhancing both its quality and presentation.

As per its preferred embodiments, in addition to temperature control, the invention is equipped with a timer function, which allows users to set the duration for which the food will remain warm. The timer can be adjusted in 30-minute increments and can be set for up to 4 hours. This feature is particularly beneficial in professional settings where food needs to be kept warm for extended periods without constant monitoring. Once the timer expires, the device automatically powers down, conserving energy and preventing the food from being overheated. This automated functionality adds convenience and reduces the need for manual intervention during events.

As per its preferred embodiments, one of the most significant advantages of this invention is its dual power mode. While the device is designed to function cordlessly via its rechargeable battery, it can also be used while plugged in through a USB-C charging port. This dual functionality ensures that the warmer can remain operational even when the battery is running low. For users in a busy catering environment or during long events, this provides peace of mind, knowing that the warmer will continue to function without interruption. Additionally, the USB-C charging port offers a universal and efficient charging method, widely compatible with modern charging systems.

The invention also includes a glass dome that covers the top plate, offering both aesthetic and functional benefits. The dome is designed with ventilation holes, which allow for airflow and prevent condensation buildup on the food. This ensures that while the food remains warm, it does not become soggy or lose its texture due to trapped moisture. The dome adds a layer of protection, shielding the food from contaminants while enhancing its presentation, making the invention ideal for formal dining events, bakeries, and catering setups where visual appeal is essential.

As per its preferred embodiments, an additional feature of the invention is the inclusion of an LED indicator light that provides a clear signal to the user when the warmer has reached the desired temperature. This visual cue helps users know exactly when the warmer is ready for use without the need for manual temperature checks. The LED light not only improves the user experience by reducing guesswork but also contributes to the product's sleek and modern design. The visual element adds a touch of sophistication, aligning the device with high-end food displays and catering presentations.

As per its preferred embodiments, the heating element is carefully designed to maintain a temperature range upto 170° F., which is ideal for keeping food warm without the risk of overcooking or drying out. This precise temperature range is especially important for baked goods and delicate desserts that require a steady warmth to preserve their freshness and texture. By ensuring that the heating element never exceeds this range, the device guarantees that food remains at an optimal temperature for serving, without compromising its taste or quality. This level of control is an improvement over traditional food warmers that may lack fine temperature regulation.

As per its preferred embodiments, structurally, the display stand portion of the warmer is built to be both sturdy and aesthetically pleasing. The stand is constructed from durable, heat-resistant materials, ensuring that it can support a variety of food items, including heavier cakes and pastries. The heating element is engraved into the surface of the top plate, creating a flush heating surface that eliminates any ridges or edges, making it easy to clean and maintain. The overall design of the warmer balances functionality with elegance, making it suitable for both casual gatherings and upscale events. Although the invention has been described in its preferred form, it is versatile enough to accommodate modifications, such as changes in size or material, without departing from the core function of keeping food warm while on display.

The assembly can be further understood by the figures provided. The figure illustrates the main components of the device. It shows the protective cover labeled 101, which helps keep the food warm by circulating air. The dessert stand housing is labeled 102, and the control buttons are marked, including 103a, the power button, and 103b, the button used to increase temperature and timer. The digital display is labeled 103c, while 103d represents the button for decreasing temperature and timer. Additionally, 103e is the timer button for quick access to timer settings.

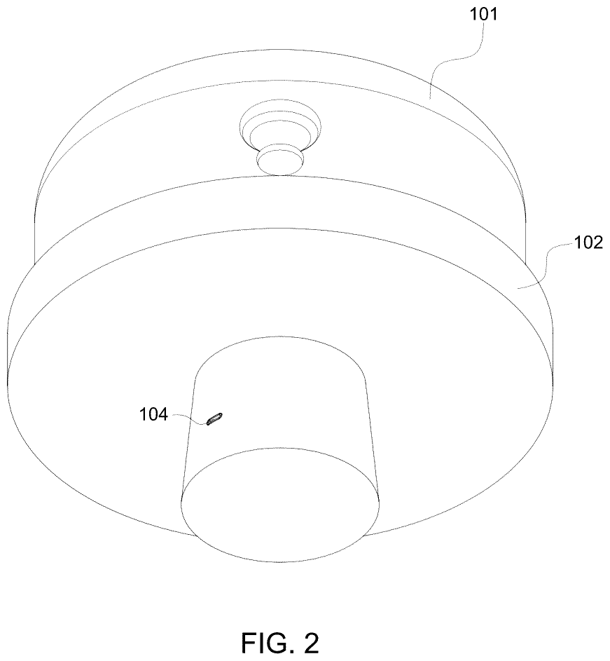

FIG. 2 focuses on the external structure of the device. It again displays the cover 101 and the dessert stand housing 102. This figure also introduces the charger input labeled 104, which is responsible for connecting the device to a power source.

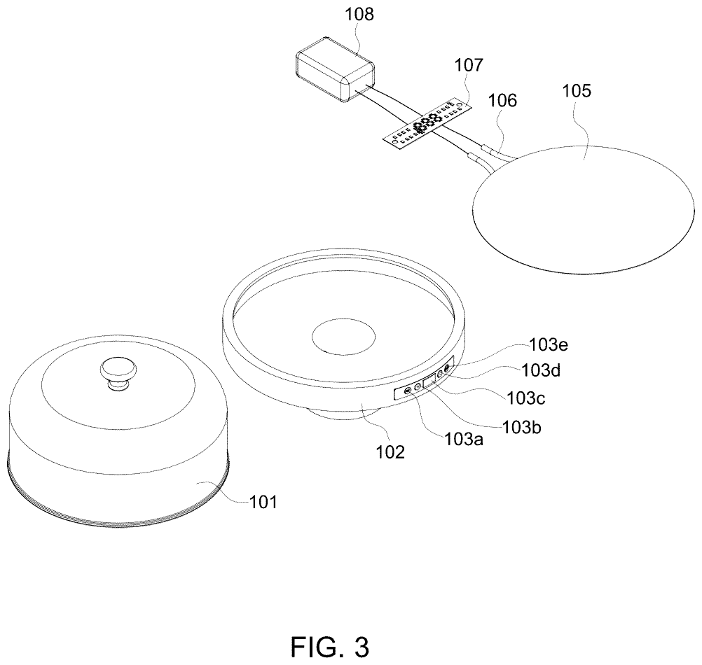

FIG. 3 shows the complete electronic and heating elements of the device are highlighted. It features the same protective cover 101 and dessert stand housing 102. The figure shows control buttons 103a through 103e, including the power button, temperature/timer controls, display, and timer button. Additionally, it introduces the top plate labeled 105, the heating element wire 106, the printed circuit board (PCB) 107, and the rechargeable battery 108.

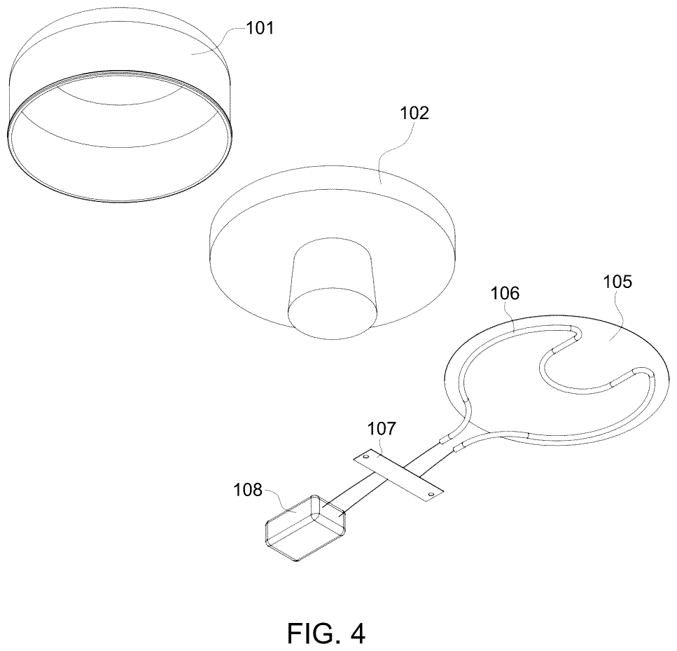

FIG. 4 emphasizes the heating and power components. The protective cover 101 and dessert stand housing 102 are again present, along with the top plate 105 and heating element wire 106. The printed circuit board 107 and rechargeable battery 108 are also shown in this figure.

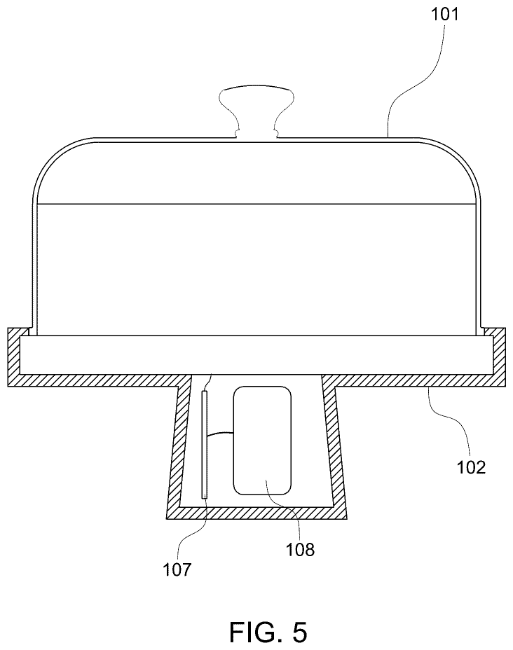

FIG. 5 focuses on the internal power system. It includes the protective cover 101, the dessert stand housing 102, and the central electronic components: the printed circuit board 107 and rechargeable battery 108.

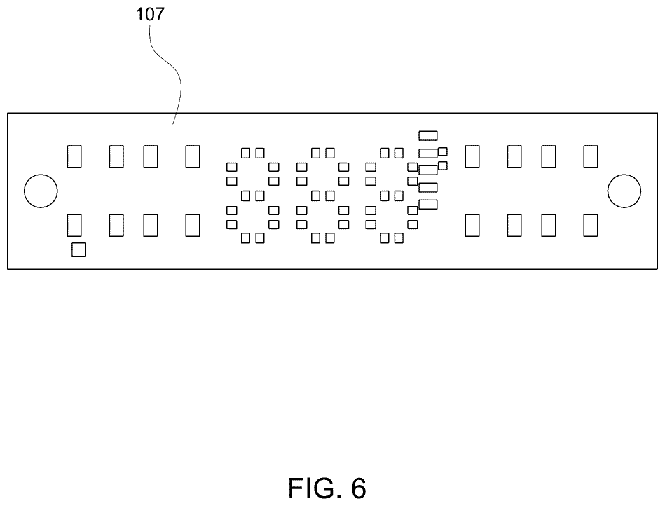

FIG. 6 isolates and magnifies the printed circuit board, labeled 107, providing a closer view of its structure and connections.

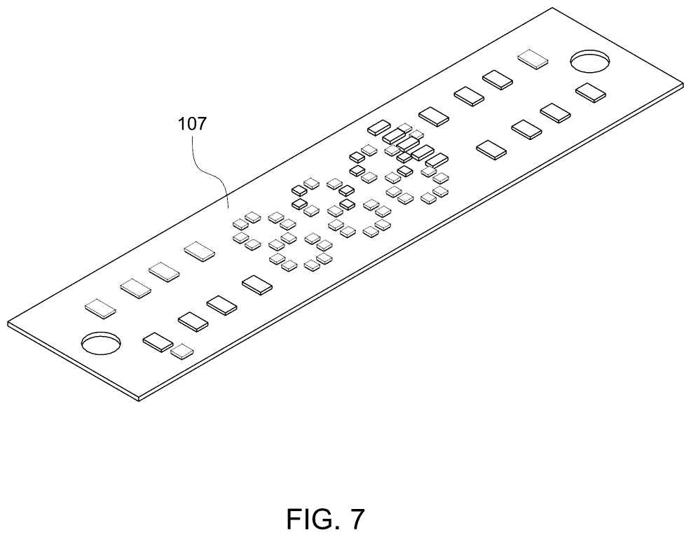

FIG. 7 similar to FIG. 6, highlights the printed circuit board 107, but with additional focus on its intricate design and connections to other internal parts of the device.

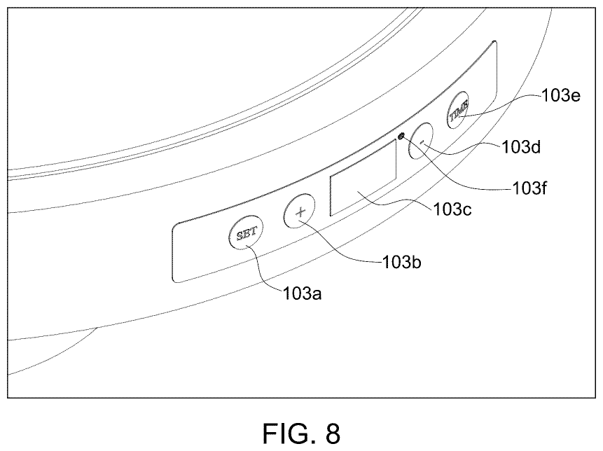

FIG. 8 highlights the control interface of the device. It shows the power button 103a, the temperature/timer increase button 103b, the digital display 103c, the temperature/timer decrease button 103d, and the timer button 103e. Additionally, it introduces a new control element, 103f, which might correspond to a secondary or additional function of the interface.

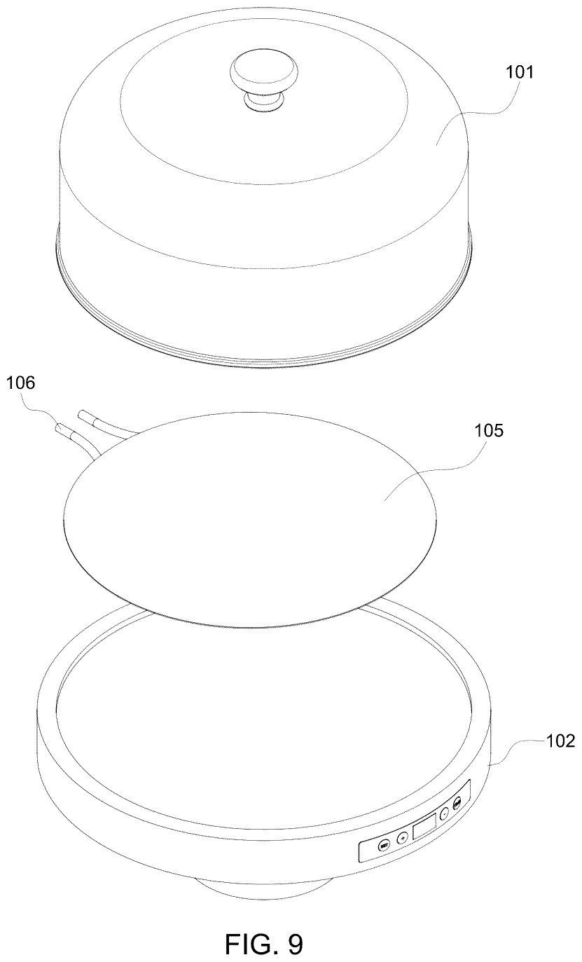

FIG. 9 illustrates the structure of the heating system. It includes the protective cover 101, the dessert stand housing 102, and the top plate 105. The heating element wire 106 is shown connected beneath the top plate, providing heat to the food stored inside.

As per its preferred embodiments, the Dessert & Food Warmer Display is an innovative solution that combines modern heating technology, portability, and aesthetic design to address the needs of both professional and domestic users. Its rechargeable battery, digital controls, and thoughtful design features make it a versatile tool for maintaining food warmth while enhancing the presentation, filling a market gap for elegant, portable food warmers that prioritize both function and form.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A Dessert & Food Warmer Display comprising:
a base with an embedded rechargeable battery;
a printed circuit board (PCB) housed within said base;
a top plate connected to said PCB, wherein said PCB is connected to both the top plate and digital display;
a digital control panel integrated with said base, said panel having buttons to adjust temperature and timer settings;
wherein said food display stand operates in both a cordless mode using said rechargeable battery and a plugged-in mode via a USB-C charging port.
The Dessert & Food Warmer Display of claim 1, wherein the USB-C port enables the stand to operate while charging, ensuring continuous use without interruption.
The Dessert & Food Warmer Display of claim 1, wherein the heating element is flush with the surface of the top plate, creating a seamless area for food placement.
The Dessert & Food Warmer Display of claim 1, further comprising an LED indicator located on the base, which illuminates when the heating element reaches the desired temperature.
The Dessert & Food Warmer Display of claim 1, wherein the glass dome includes ventilation holes evenly distributed to allow heat to escape while preventing condensation on the food.
The Dessert & Food Warmer Display of claim 1, wherein the base and top plate are made of heat-resistant materials designed to support various food items, including cakes and other baked goods, without deformation or instability.
The Dessert & Food Warmer Display of claim 1, wherein the timer function includes an automatic shutoff feature that disables the heating element when the set timer expires.
The Dessert & Food Warmer Display of claim 1, wherein a temperature sensor in the PCB allowing the glass top plate temperature to be displayed on the digital display.
The Dessert & Food Warmer Display of claim 1, further comprising a removable and washable cover for the base and top plate to ensure easy cleaning and maintenance.
The Dessert & Food Warmer Display of claim 1, wherein the device has a safety override feature that disables the heating element if the temperature exceeds a predefined safe limit.

2. The Dessert & Food Warmer Display, wherein the heating element in the top plate is capable of maintaining a temperature up to 170° F., and wherein the digital control panel allows a user to set the temperature using + and − buttons.

3. The Dessert & Food Warmer Display, further comprising a glass dome with ventilation holes, is designed to cover food items placed on the top plate, allowing heat circulation and preventing moisture buildup.
